(19) United States
(12) Patent Application Publication
(10) Pub. No.: US 2001/0018827 A1
(43) Pub. Date: Sep. 6, 2001

(54) Engine exhaust system and adapter therefor

(76) Inventors: Judy Rhode, San Juan Capistrano, CA (US); Rodney Lee Asher, San Clemente, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/736,889

(22) Filed: Dec. 12, 2000

Related U.S. Application Data
(63) Continuation-in-part of application No. 09/429,089, filed on Dec. 14, 1999, now abandoned.

(51) Int. Cl. F01N 1/00; F02B 27/02

(52) U.S. Cl. 60/312; 60/314; 60/272

(57) ABSTRACT

A combination recessed port of an internal combustion engine having a depth and inside diameter dimensions, and an adapter tube of a length exceeding the depth dimension of the recessed port, and an exhaust pipe having an inside diameter at least as large as the inside diameter of the recessed port and an outside diameter dimension greater than the inside diameter dimension of the recessed port provides improved engine efficiency and operation. The adapter tube is formed as an open ended cylinder providing an outer cylindrical surface having an annular lip formed medially, and a tapered annular surface at a distal end for mating with the exhaust pipe. The adapter inside diameter is smaller than the diameter of the exhaust port and is of such length as to enable exhaust flow to pass completely through the adapter prior to the next discharge. Upon expansion of each exhaust discharge as it enters the exhaust pipe, a partial vacuum is formed inside the adapter which tends to provide suction for drawing the next discharge out of the engine.

The present invention is a continuation-in-part and therefore claims the priority date of a prior filed utility patent application having Ser. No. 09/429,089 and an official filing date of Dec. 14, 1999 and which discloses substantially the same material as described herein.

### BACKGROUND OF THE INVENTION

1. Field of the Invention

This invention relates generally to manifolds and more particularly to exhaust pipe systems and most particularly to adaptors for such systems.

2. Description of Related Art

The following art defines the present state of this field:

Michikawa, U.S. Pat. No. 4,339,918 teaches a means for accelerating the discharge of exhaust gas from an internal combustion engine, which is adapted to be mounted to the end of the engine exhaust pipe, in which exhaust gas from the engine is swirlingly guided by a plurality of spiral blades disposed in a tubular member, to for a super low pressure space at the center of the exhaust gas flow, thereby to accelerate the discharge of the exhaust gas.

Morehead et al, U.S. Pat. No. 5,821,475 teaches a venturi muffler with variable throat area.

The prior art teaches the use of exhaust systems and mufflers for internal combustion engines but does not teach an adaptor of the instant type for improving the exhaust characteristics of an exhaust pipe system by improving conductance. The present invention fulfills these needs and provides further related advantages as described in the following summary.

### SUMMARY OF THE INVENTION

The present invention teaches certain benefits in construction and use which give rise to the objectives described below.

Motorcycles and other machines generally use an exhaust pipe designed to expel exhaust gases at an appropriate location. Most often these exhaust pipes are exhaust systems with some complexity since large engines have multiple exhaust ports and these are spaced apart with various configurations. In the present application we consider the simple case of a single engine exhaust port of a common type, i.e., a recessed port. The invention considers the combining of such a port outlet for a single engine cylinder through a single exhaust valve and combines a common cylindrical exhaust pipe plus a special adapter, which is the heart of the invention. It is this combining of these elements in such a manner as to achieve improved engine performance that is the focus of this invention and importantly, also the structure of the adapter which make it possible. Therefore, the present invention is a combination recessed port of an internal combustion engine having a depth and inside diameter dimensions, and an adapter tube of a length exceeding the depth dimension of the recessed port, and an exhaust pipe having an inside diameter at least as large as the inside diameter of the recessed port and an outside diameter dimension greater than the inside diameter dimension of the recessed port provides improved engine efficiency and operation. The adapter tube is formed as an open ended cylinder providing an outer cylindrical surface having an annular lip formed medially, and a tapered annular surface at a distal end for mating with the exhaust pipe. The adapter inside diameter is smaller than the diameter of the exhaust port and is of such length as to enable exhaust flow to pass completely through the adapter prior to the next discharge. Upon expansion of each exhaust discharge as it enters the exhaust pipe, a partial vacuum is formed inside the adapter which tends to provide suction for drawing the next discharge out of the engine.

A primary objective of the present invention is to provide an apparatus and method of use of such apparatus that provides advantages not taught by the prior art.

Another objective is to provide such an invention capable of providing an improved operation of an internal combustion engine.

A further objective is to provide such an invention capable of adapting a standard exhaust system to a high efficiency exhaust system, i.e., larger diameter exhaust pipe.

A still further objective is to provide such an invention capable of boosting or accelerating the outflow of the exhaust gases from an exhaust port of an engine.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of an adapter and a portion of an exhaust pipe of the preferred embodiment of the invention; and

FIG. 2 is a sectional view of the invention.

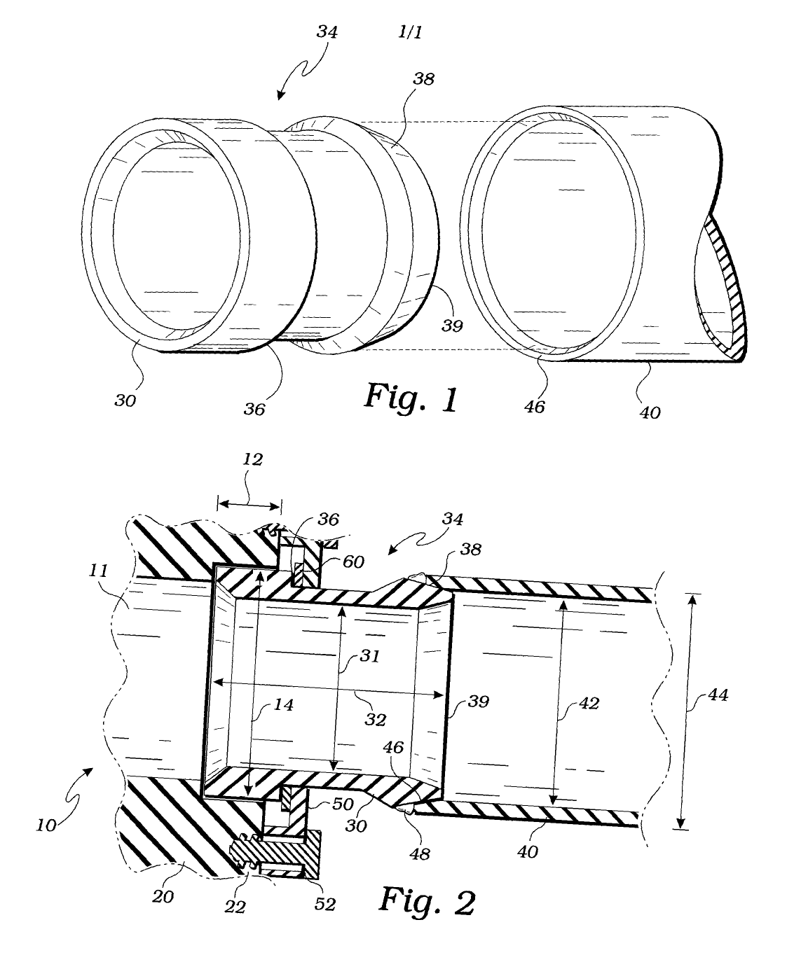

### DETAILED DESCRIPTION OF THE INVENTION

The above described drawing figures illustrate the invention in at least one of its preferred embodiments, which is further defined in detail in the following description.

The invention is a combination of three operating elements. The first of these elements is a recessed port 10 of an internal combustion engine 20 as seen in FIG. 2 where the internal combustion engine is only shown in part with an exhaust channel 11 leading from the engines exhaust valve or valves (not shown) to the recessed port 10 which has a depth shown by the arrow marked 12, and an inside diameter dimension shown by the arrow marked 14. The second element in this invention is an adapter tube 30 having a length 32 which exceeds the depth dimension 12 of the recessed port 10, so that the adapter tube 30 extends outwardly from the engine 20. The third element of the invention is an exhaust pipe 40, typically a cylinder having an inside diameter 42 which is at least as large as the inside diameter dimension 14 of the recessed port 10 so that exhaust conductance is not throttled. The exhaust pipe 40 has an outside diameter dimension 44 generally greater than the inside diameter dimension 14 of the recessed port 10 so that it is not usually possible for the exhaust pipe 40 to be fitted directly into the recessed port 10. Now the recessed port diameter 14 could be enlarged to accept an exhaust pipe with a larger outside diameter but, as is well known, surface space on the exterior of an internal combustion engine 20 is at a premium, especially for air cooled machines.

The adapter tube 30 is formed as an open ended cylinder, the cylinder providing an outer cylindrical surface 34 having an annular lip 36 formed medially, and a tapered annular surface 38 at a distal end 39.

The invention preferably further comprises a clamping ring 50 adapted with an aperture allowing contact with the annular lip 36 so as to compress the adapter tube 30 into the recessed port 10. A plurality of bolt holes 52 in the clamping ring 50 correspond with a further plurality of threaded fastening holes 22 positioned about the recessed port 10 in the side wall of the internal combustion engine 20. Depending on the shape of the clamping ring 50, the depth 12 of the recessed port 10, and other variables, an adapter ring 60 may be used to assure tight clamping pressure as seen in FIG. 2.

The exhaust pipe 40 preferably provides a tapered interior surface 46 at the end thereof that engages the adapter tube 30 so that smooth mating with the tapered annular surface 38 of the adapter tube 30 is possible. These two elements are joined most conveniently by TIG welding with weld material shown as numeral 48 in FIG. 2.

The interior diameter 31 of the adapter tube 30 is smaller than the inside diameter 14 of the exhaust port channel 11 which inserts a slight obstruction in the path of the exhaust gases. Also, the length of the adapter tube 32 is defined by the distance traveled by an exhaust gas molecule between engine exhaust cycles. It has been discovered that the combination of a slight obstruction and reduction in the conductance of an exhaust pipe system, such as that of the present invention coupled with a length of such obstruction, i.e., enabling the exhaust flow of one exhaust cycle to pass completely through the adapter prior to the next discharge, results in improved engine performance. It is believed that this occurs because upon expansion of each exhaust discharge as it enters the larger exhaust pipe 40 from the adapter tube 30, a partial vacuum is formed inside the adapter which provides a slight improvement in suction for drawing the next discharge out of the engine as the exhaust port opens. This effect is only significant when the adapter tube 30 is placed very close to the exhaust valve.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A combination comprising: a recessed port of an internal combustion engine, the recessed port having a depth and inside diameter dimensions of a recess thereof, an adapter tube of a length exceeding the depth dimension of the recess, and an exhaust pipe having an inside diameter at least as large as the inside diameter dimension of the recessed port and an outside diameter greater than the inside diameter dimension of the recessed port.

2. The combination of claim 1 wherein the adapter tube is formed as an open ended cylinder, the cylinder providing an outer cylindrical surface, the cylindrical surface having an annular lip formed medially, and a tapered annular surface at a distal end.

3. The combination of claim 1 further comprising a clamping ring adapted for contact with the annular lip and a plurality of bolt holes corresponding with a further plurality of fastening holes about the recessed port in the internal combustion engine.

4. The apparatus of claim 3 further comprising an adapter ring.

5. The apparatus of claim 2 wherein the exhaust pipe provides a tapered interior surface at an end thereof mating with the tapered annular surface of the adapter tube.

6. The apparatus of claim 1 wherein the interior diameter of the adapter tube is smaller than the inside diameter of the exhaust port and the length of the adapter tube is defined by a distance traveled by an exhaust gas molecule between engine exhaust cycles.

7. An adapter apparatus for use with a recessed port of an internal combustion engine, the recessed port having a depth and inside diameter dimensions of a recess thereof and with a cylindrical exhaust pipe, the adapter comprising: an adapter tube of a length exceeding the depth dimension of the recess, the adapter tube formed as an open ended cylinder providing an outer cylindrical surface, the cylindrical surface having an annular lip formed medially, and a tapered annular surface at a distal end an interior diameter smaller than the inside diameter of the recessed port and whereby the length of the adapter tube is defined by a distance traveled by an exhaust gas molecule between engine exhaust cycles.
